(19) United States
(12) Patent Application Publication
(10) Pub. No.: US 2011/0278093 A1
(43) Pub. Date: Nov. 17, 2011

(54) LADDER STABILIZING DEVICE

(76) Inventor: James E. La Rock, Kent City, MI (US)

(21) Appl. No.: 12/777,669

(22) Filed: May 11, 2010

(51) Int. Cl. E06C 7/46

(52) U.S. Cl. 182/107

(57) ABSTRACT

A ladder stabilizing device having an arm and a hand. The arm is adapted to fit into the receiver of a vehicle. The hand pivotally mounts to the arm and may be securable in different angular orientations relative to the arm. A lateral member of the hand stabilizes the ladder and reduces the risk of the ladder sliding rearward and out from under the user while the user is climbing and/or standing on the ladder. Two extensions extend from the lateral member to limit lateral movement of the ladder while a user is climbing the ladder. The arm may include three or more offset sections that allow for vertical or horizontal adjustment of the hand. Rearward movement and/or flexing of the ladder may cause the ladder to wedge under the lateral member, providing additional stability to the ladder.

### BACKGROUND

The present invention relates to ladder accessories and more particularly to stabilizing devices for ladders.

Ladders have been in widespread use for many years. Unfortunately, the use of a ladder is accompanied by a certain amount of danger. If the surface supporting the legs of the ladder does not have enough friction, the ladder may slip, possibly causing the person using the ladder to fall and/or injure themselves. The risk increases when the user exerts larger outward or downward forces on the ladder. To reduce this risk, ladders have been equipped with many different stabilizing devices.

One prior art device includes stakes that are driven into the ground or surface supporting the ladder. The stakes semi-permanently affix the ladder to the ground, which provides stabilization for the ladder, but leaves unsightly holes after the ladder is removed. This device also takes time to install and remove. In some situations, the surface characteristics may not allow for the use of stakes, for example, when using a ladder on a paved surface.

Other prior art devices attach supporting legs to the bottom of a ladder. These devices may stabilize the ladder in some situations, but can still suffer from the danger of slipping out from under a user when the surface supporting the ladder has a low coefficient of friction, as mentioned above. These devices may also be less effective when the user is exerting large outward or downward forces on the ladder.

Still other prior art devices add supporting arms to the top of the ladder to improve the stability between the top of the ladder and the surface supporting the top of the ladder. These devices may stabilize the top of a ladder, but add relatively little stability to the bottom of a ladder. In some situations, a suitable surface supporting the top of the ladder may not be available to engage a ladder stabilizer of this type.

Although existing ladder stabilizers provide a solution for some applications, there remains a continuing need for an improved ladder stabilizer that provides enhanced and efficient functionality, such as when large forces are applied to the ladder and/or low coefficients of friction are involved in supporting the ladder.

### SUMMARY OF THE INVENTION

The present invention provides a ladder stabilizing device that is adapted to attach to a vehicle. The device has an arm extending from a vehicle that, in one embodiment, may be insertable into the receiver of the vehicle. A hand may be pivotally attached to the arm and may interact with a lower portion of a ladder. The hand may be moveable between three angular positions to provide increased adaptability. The hand may include one lateral member to limit rearward movement of the ladder and two extension members to limit lateral movement of the ladder. The arm may be made of a material sufficiently flexible to allow bowing that can wedge the ladder in the stabilizing device if the ladder slides and/or flexes during use.

In another embodiment, the hand is moveable between more than three angular positions. Two pins may be used to allow the hand to pivot and to secure the hand in the various angular positions.

In yet another embodiment, the arm may include two parallel members joined by an angular member, which increases the possible orientations and adaptability of the ladder stabilizing device. The arm may be inserted into a receiver in four different orientations, which allows for vertical and horizontal adjustment of the position of the hand relative to the vehicle.

The present invention provides a ladder stabilizing device with enhanced and efficient functionality. The device includes an arm and a hand hingedly attached to the arm. The arm may be insertable into the receiver of a vehicle, which provides stability on nearly all conceivable surfaces on which a ladder would be used. The receiver also provides a fast and relatively simple attachment. The interface surfaces of the arm and hand may matingly engage one another, which provides enhanced stability of the device. The device may be adapted to different ladder styles and environmental conditions through the shape of the arm and the angular position of the hand.

These and other features of the invention will be more fully understood and appreciated by reference to the description of the embodiments and the drawings.

### BRIEF DESCRIPTION OF THE DRAWINGS

FIG. 1 is a perspective view of a portion of a ladder stabilizing device in accordance with an embodiment of the present invention.

FIG. 2 is a perspective view of the embodiment of FIG. 1 with the hand rotated.

FIG. 3 is a perspective view of the hand of the embodiment of FIG. 1.

FIG. 4 is a perspective view of the embodiment of FIG. 1 interacting with a vehicle and a ladder.

FIG. 5 is a perspective view of the embodiment of FIG. 1 interacting with a vehicle and a ladder.

FIG. 6 is a perspective view of the embodiment of FIG. 1 with the hand rotated and the device interacting with a vehicle and a ladder.

FIG. 7 is a perspective view of the embodiment of FIG. 1 illustrating the wedging action of the ladder.

FIG. 8 is a top view of the embodiment of FIG. 1 with the hand rotated.

FIG. 9 is a top view of the embodiment of FIG. 1.

FIG. 10 is a top view of a second embodiment of the invention.

FIG. 11 is a perspective view of the embodiment of FIG. 10.

FIG. 12 is a perspective view of a third embodiment of the invention.

FIG. 13 is a side view of the embodiment of FIG. 12.

### DESCRIPTION OF EMBODIMENTS

The embodiments of the present invention provide a ladder stabilizing device that is adapted to attach to a vehicle. The vehicle has a receiver that may be located toward the rear of the vehicle. The receiver may be any type of receiver, including but not limited to a trailer hitch receiver. The device includes a hand that may be pivotally attached to an arm and secured in a plurality of angular positions relative to the arm. The arm may be insertable into the vehicle receiver.

### I. First Embodiment

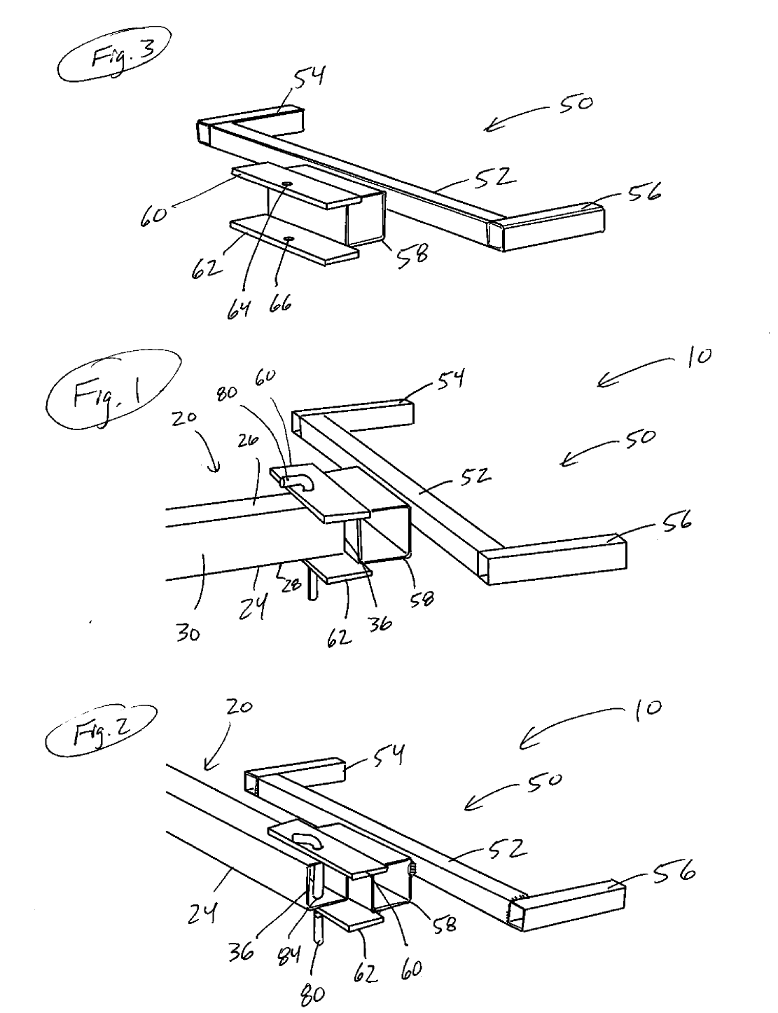

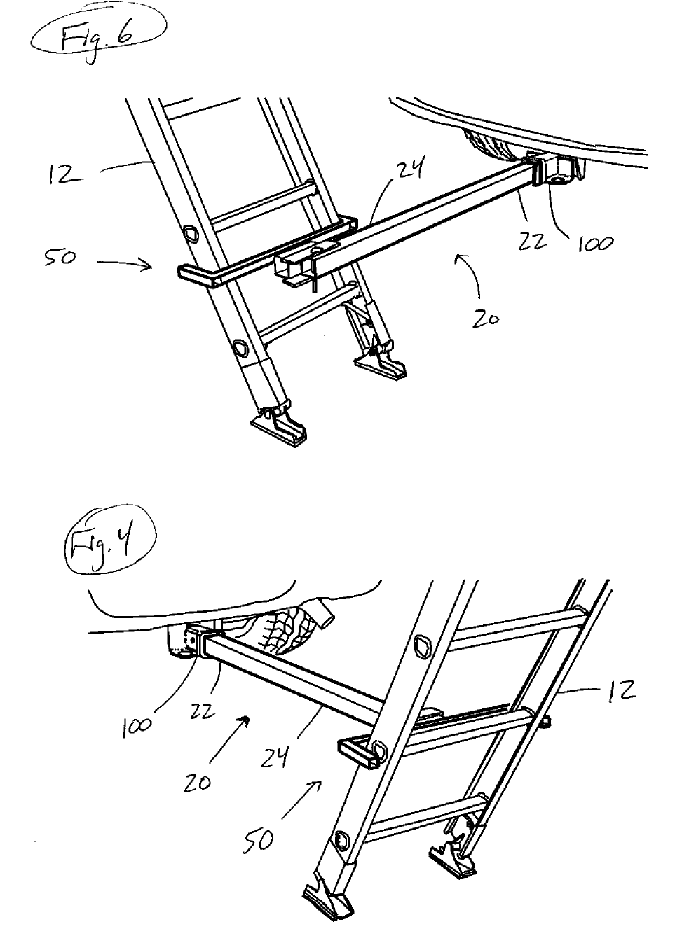

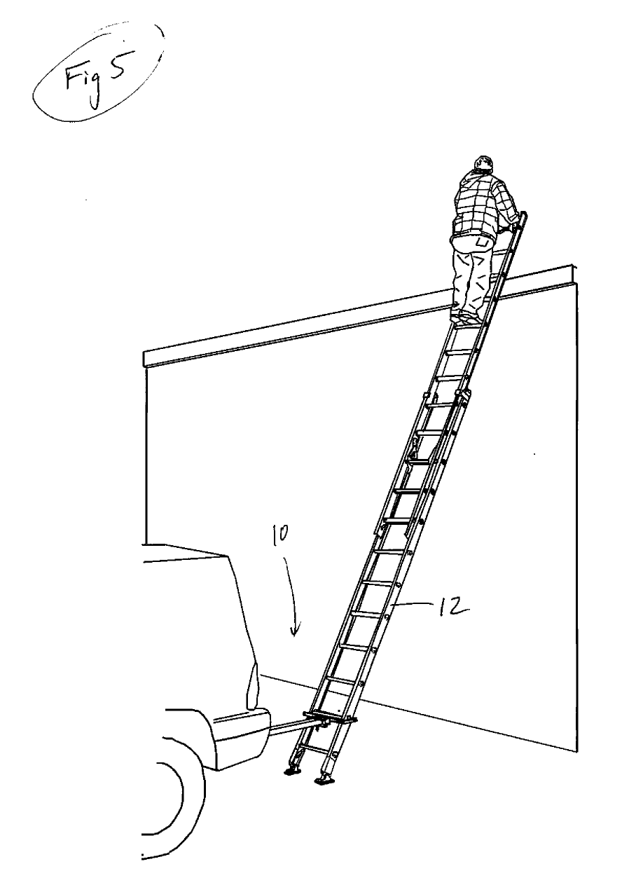

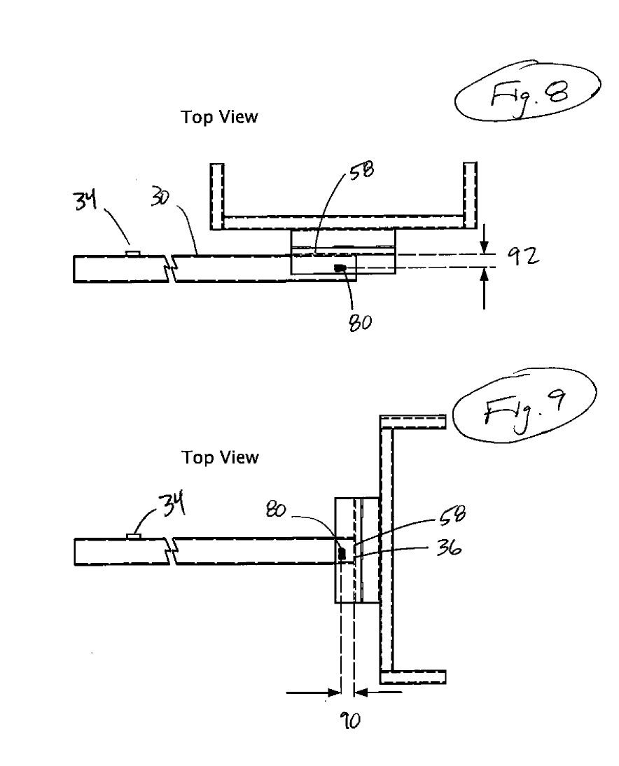

A ladder stabilizing device 10 in accordance with a first embodiment of the present invention is shown in FIGS. 1-9. The device 10 generally includes an arm 20 and a hand 50. Arm 20 and hand 50 may be of any size or material suitable for the application, including steel, aluminum or composite tube stock. For example, arm 20 and hand 50 may have an outer dimension of 2 inches and a wall thickness of ⅛ inch. Arm 20 and hand 50 preferably include hollow components, but may include solid components or a combination of hollow and solid components. The arm 20 includes a first portion 22 and a second portion 24. As shown in FIGS. 4 and 6, the first portion 22 may be inserted into the receiver 100 of a vehicle. As shown in FIGS. 8 and 9, arm 20 may include a receiver tab 34 that engages receiver 100 to stabilize device 10. The figures do not show a pin securing arm 20 to receiver 100, but one may be included. The second portion 24 is connected to hand 50 with hinge pin 80. Arm 20 includes two apertures 82, 84 for receiving hinge pin 80. Optionally, arm 20 may include two or more sections slidably connected that allow a user to increase and decrease the length of arm 20. Any conventional locking feature may be used to secure the two sections at the desired length. This may allow for further adjustment of the arm 20 after the vehicle is parked.

Hand 50 includes a lateral member 52 and two extension members 54, 56. Lateral member 52 is affixed to a mounting member 58 and extension members 54, 56 are affixed to lateral member 52. These connections and any connection in device 10 may be accomplished with any means suitable to the application, including but not limited to welding, threaded and non-threaded fasteners, and adhesives. Two plates 60, 62 are affixed to the top and bottom surfaces of mounting member 58 and include apertures 64, 66 for receiving hinge pin 80. As shown in FIGS. 1-3, plates 60, 62 extend past the side of mounting member 58. The height of mounting member 58 may be designed such that upper surface 26 and lower surface 28 of arm 20 interface with and engage plates 60, 62. In other words, the height of mounting member 58 may be substantially equivalent to the distance between the upper surface 26 and lower surface 28 of arm 20.

There are a variety of design options for hand 50 that will be apparent to those of ordinary skill in the art. Optionally, lateral member 52 may be sized to position extension members 54, 56 wider than a conventional ladder or to correspond to a particular ladder width. Further optionally, lateral member 52 may include two or more pieces slidably connected that allow lateral member 52 to increase and decrease in length, which may allow the distance between extension members 54, 56 to be adjusted to accommodate various sizes of ladders. Any conventional locking feature may be used to secure the two pieces of lateral member 52 at the desired length. Further optionally, two members may be attached to extension members 54, 56 that extend toward one another to partially enclose ladder 12. Further optionally, a closure member may be included that connects the ends of extension members 54, 56. The closure member would provide a completely enclosed space between lateral member 52, the closure member and the extension members 54, 56 in which to place ladder 12. Further optionally, extension members 54, 56 may include clamps that secure ladder 12. Further optionally, hand 50 may include a knuckle that enables hand 50 to tilt relative to arm 20, which would provide adaptability for the ladder stabilizing device 10.

As shown in FIGS. 1, 2 and 6, hand 50 may be secured in three different angular positions relative to arm 20. As shown in FIG. 9, plates 60, 62 are designed such that the distance 90 between mounting member 58 and hinge pin 80 is equal to the distance 90 between the outer surface 36 of arm 20 and hinge pin 80. This allows the outer surface 36 of arm 20 to interface with and engage mounting member 58, increasing the stability of device 10 when hand 50 is in the orientation shown in FIG. 9. As shown in FIG. 8, distance 90 is also equal to a distance 92 between hinge pin 80 and the side surface 30 of arm 20. This allows the side surface 30 of arm 20 to interface with and engage mounting member 58 when hand 50 is in the orientation shown in FIG. 8, which increases the stability of device 10. In all three of the angular orientations shown in FIGS. 1, 2 and 6, the surface interface locks the hand in position and increases the stability of device 10.

In use, the vehicle may be stopped a distance from the intended ladder location. Ladder 12 may be placed in position and the user may determine which vehicle orientation would be best to support ladder 12. For this decision, a user might consider the environment surrounding ladder 12 including curbs, other obstructions and overall potential vehicle access. A user may also consider the nature of the work to be done including any required clearances, tools and equipment that may be required while the user is on ladder 12 and any other relevant considerations. Once the user decides the best vehicle orientation, the user may place the first portion 22 of arm 20 into receiver 100.

Arm 20 may be inserted into vehicle receiver 100. Using the same considerations mentioned above, the user may determine which orientation to use for hand 50. If arm 20 and hand 50 are stored separately, the user may retrieve hand 50 and align the space between plates 60, 62 with the outer end 36 of arm 20. If different angular orientations for hand 50 are used, the corresponding surface mating with mounting member 58 would be aligned with the space between plates 60, 62. For example, if a side orientation is desired, as shown in FIG. 2, the user would align the space between plates 60, 62 with the side surface 30 of arm 20. The outer end 36 of arm 20 is inserted into the space between plates 60, 62 such that the apertures 82, 84 in arm 20 align with the holes 64, 66 in hand 50. The hinge pin 80 is inserted through the apertures 64, 66, 82, 84. If the length of lateral member 52 is adjustable, the user may secure lateral member 52 at a desired length to accommodate the width of the ladder 12.

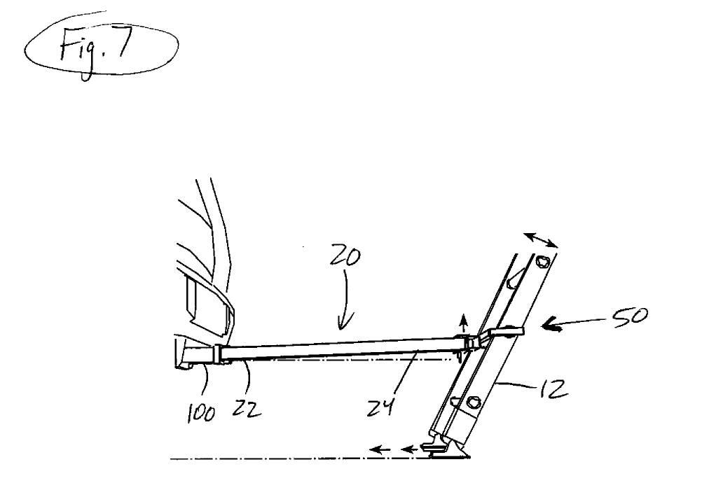

The vehicle may then be moved into position. The user may first position ladder 12 and then approach ladder 12 with the vehicle, or optionally, the user may position the vehicle and then position ladder 12. Using either sequence, ladder 12 may be positioned between extension members 54, 56 and adjacent lateral member 52. The user may adjust the length of arm 20 if the length of arm 20 is adjustable. If the length of lateral member 52 is adjustable, the user may adjust the length of lateral member 52, which adjusts the distance between extension members 54, 56. The user may climb ladder 12, which is stabilized by ladder stabilizing device 10. As the user climbs ladder 12, the legs of ladder 12 may slide toward the vehicle and toward ladder stabilizing device 10. In addition, ladder 12 may flex under the weight of the user. As shown in FIG. 7, either or both of ladder 12 sliding and flexing may cause ladder 12 to contact lateral member 52 and cause hand 50 to move upward relative to its original orientation. As hand 50 moves upward, arm 20 may flex, and ladder 12 may become wedged in stabilizing device 10, providing further increased stability. The flexing of ladder 12 is not explicitly shown in FIG. 7, but the flexing of ladder 12 may contribute to the wedging of ladder 12 in stabilizing device 10, as described above. To facilitate this wedging action, arm 20 may be made with a material having sufficient flexibility, such as the steel or aluminum tube stock noted above.

After the user completes the task and no longer needs ladder 12, ladder 12 may be removed from stabilizing device 10, and hand 50 may be detached from arm 20 by removing pin 80. Optionally, arm 20 and hand 50 may be stored affixed to one another to reduce the time required to assemble ladder stabilizing device 10. If stored in an affixed configuration, hand 50 may be rotated to the side to reduce the width of device 10.

### II. Second Embodiment

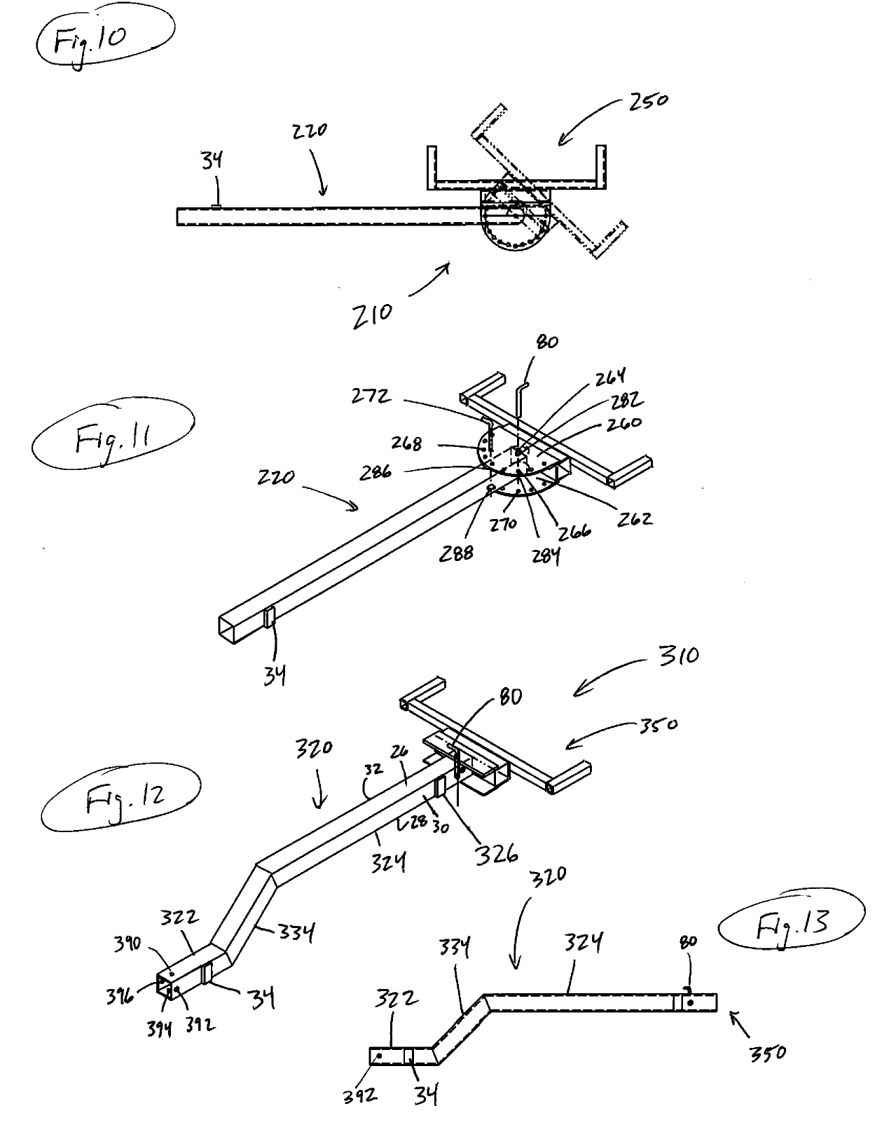

A ladder stabilizing device 210 in accordance with a second embodiment of the invention is shown in FIGS. 10-11. In this embodiment, hand 250 may be oriented at more than three angular positions relative to arm 220. Arm 220 has apertures 282, 284 for receiving hinge pin 80 and apertures 286, 288 for receiving angular pin 272. Plates 260, 262 have apertures 264, 266 for receiving hinge pin 80. Plates 260, 262, also have a plurality of apertures 268, 270 into which angular pin 272 may be inserted to orient hand 250 at a desired angle relative to arm 220.

In use, hand 250 is secured to arm 220 by inserting hinge pin 80 through apertures 264, 266, 282, 284. Hand 250 is oriented at the desired angle relative to arm 220 and secured at the desired angle by inserting angular pin 272 through apertures 268, 270, 286, 288. In this embodiment, a clearance distance is required between the end of arm 220 and hand 250 to allow rotation of hand 250 relative to arm 220. After use, the user may remove pins 80, 272 to remove hand 250 from arm 220.

### III. Third Embodiment

A ladder stabilizing device 310 in accordance with a third embodiment of the invention is shown in FIGS. 12-13 and includes arm 320 and hand 350. In this embodiment, the arm 320 includes two substantially parallel segments 322, 324 joined by a segment 334 oriented at an angle to both parallel segments 322, 324. Arm 320 may be rotated to four different angular orientations relative to receiver 100, which allow for vertical and horizontal adjustment of hand 350. Arm 320 defines apertures for the hinge pin 80 through sides 26, 28, 30, 32, which allows hand 350 to be secured to arm 320 when arm 320 is in each of the four orientations. In this and all embodiments, the arm 320 may define apertures that allow a pin to secure arm 320 to receiver 100. Specifically, the third embodiment includes apertures 390, 392, 394, 396 to allow securing of arm 320 in receiver 100 in each of the four orientations. As shown in FIG. 12, arm 320 may include a hand engagement tab 326 to stabilize hand 350 when hand 350 is secured against side 30 of arm 320.

In use, the user must decide which arm orientation would be best for the application. The user may consider the same factors already mentioned, plus any other applicable considerations. After determining the desired orientation, the user may insert the arm 320 in the desired orientation in receiver 100. The user then may secure hand 350 to arm 320 with pin 80.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A ladder stabilizing device comprising:
an arm having a receiver end configured to selectively mount in a receiver on a vehicle; and
a hand pivotally mounted to said arm about a generally vertical pivot axis, said arm adapted to simultaneously surround a ladder on at least three sides when the ladder is in a generally upright position;
wherein said hand is able to be secured in different angular orientations about the generally vertical pivot axis relative to said arm, and
wherein said arm and said hand extend within substantially the same plane,
whereby the ladder can be supported on the ground and wedged beneath said hand with a bottom of the ladder engaging the ground beneath said arm.

2. The ladder stabilizing device of claim 1 wherein said hand is able to be rigidly secured in three different angular orientations about the vertical pivot axis relative to said arm.

3. The ladder stabilizing device of claim 1 including a hinge pin wherein:
said hand includes a top plate, a bottom plate, and a mounting member,
said arm includes a top surface and a bottom surface,
the top plate is substantially parallel to the top surface of the arm and the bottom plate is substantially parallel to the bottom surface of the arm,
the top plate engages the top surface of said arm and the bottom plate engages the bottom surface of said arm,
said hand and said arm are secured together by the hinge pin inserted through the top plate of said hand, said arm, and the bottom plate of said hand,
the distance between said mounting member and said hinge pin is equal to the distance between a front outer surface of the arm and said hinge pin, the distance between a first side surface of the arm and said hinge pin and the distance between a second side surface of the arm and said hinge pin.

4. The ladder stabilizing device of claim 1 wherein said hand is able to be rigidly secured at more than three angles about the vertical pivot axis relative to said arm.

5. The ladder stabilizing device of claim 4 wherein said hand is able to be rigidly secured at more than three angles about the vertical pivot axis relative to said arm with at least two pins inserted through said hand and said arm.

6. The ladder stabilizing device of claim 1 wherein said hand includes a lateral member and two extensions extending in a direction substantially perpendicular to said lateral member.

7. The ladder stabilizing device of claim 1 wherein said hand is adapted to simultaneously surround the ladder on four sides when the ladder is in the upright position.

8. The ladder stabilizing device of claim 1 wherein said arm includes a first section configured to mount in the receiver of a vehicle, a second section connected to the first section and a third section connected to the second section and pivotally attached to the hand, said first section, said second section, and said third section positioned in substantially the same plane.

9. A ladder stabilizing system for use with a vehicle having a receiver comprising:
a longitudinally extending member;
a first portion of said member adapted to be selectively inserted into the receiver;
a third portion of said member being shaped to surround a ladder on at least three sides when the ladder is in an upright position; and
a second portion of said member extending from said first portion to said third portion,
whereby the ladder can be supported on the ground and wedged beneath said hand with a bottom of the ladder engaging the ground beneath said arm.

10. The ladder stabilizing device of claim 9 wherein:
said first portion, said second portion and said third portion are positioned substantially in one horizontal plane, and
said third portion is releasably secured to said second portion.

11. The ladder stabilizing device of claim 10 wherein said third portion is releasably secured to said second portion with a pin inserted through the top plate, said second portion, and the bottom plate.

12. The ladder stabilizing device of claim 11 wherein said third portion is rigidly securable at three different angles about a substantially vertical pivot axis relative to said second portion with the pin.

13. The ladder stabilizing device of claim 11 wherein said third portion is rigidly securable at more than three different angles about a substantially vertical pivot axis relative to said second portion, the third portion rigidly securable with at least two pins inserted through the top plate, the arm, and the bottom plate.

14. The ladder stabilizing system of claim 9 wherein said third portion includes two members substantially parallel to one another, the two members extending from a lateral member for surrounding the ladder on at least three sides.

15. A stabilization device for a ladder comprising:
an arm having a first end and a second end, said first end adapted to mount within a receiver in a vehicle;
a hand having a first lateral member movably mounted to said second end, said hand rotatable about a substantially vertical pivot axis between a first position in which said first lateral member extends generally perpendicularly to a longitudinal extent of said arm and a second position in which said first lateral member extends generally parallel to said longitudinal extent of said arm,
wherein the arm and the hand generally extend within a substantially horizontal reference plane, and
whereby the ladder can be supported on the ground and wedged beneath said hand with a bottom of the ladder engaging the ground beneath said arm.

16. The stabilization device of claim 15 wherein said first lateral member is adapted to limit a rearward movement of the ladder;
said hand including a second lateral member spaced apart from said first lateral member and adapted to limit a forward movement of the ladder, and said hand including first and second extension members connecting said first and second lateral members and adapted to limit a lateral movement of the ladder.

17. The stabilization device of claim 16 wherein said second lateral member is releasably connected to said extension members.

18. The stabilization device of claim 15 wherein:
said arm includes a top surface and a bottom surface,
said first lateral member includes a rear surface,
said hand includes a mounting member adjacent the first lateral member with a front surface, a rear surface, a top surface and a bottom surface,
said front surface of said mounting member is permanently connected to said first lateral member,
said hand includes a top plate permanently attached to the top surface of the mounting member and engaging the top surface of said arm,
said hand includes a bottom plate permanently attached to the bottom surface of the mounting member and engaging the bottom surface of said arm.

19. The stabilization device of claim 18 wherein said hand and said arm are pivotally connected with a pin inserted through the top plate, said arm, and the bottom plate.

20. The stabilization device of claim 19 wherein said arm is hollow, such that a front side of said arm defines a front edge,
wherein the front edge engages the rear surface of the mounting member.
